(19) United States
(12) Patent Application Publication
(10) Pub. No.: US 2016/0293157 A1
(43) Pub. Date: Oct. 6, 2016

(54) Contextual Voice Action History

(71) Applicant: Google Inc., Mountain View, CA (US)

(72) Inventors: Brian Chen, Santa Clara, CA (US); Vikram Aggarwal, Mountain View, CA (US)

(21) Appl. No.: 14/710,123

(22) Filed: May 12, 2015

Related U.S. Application Data
(60) Provisional application No. 62/140,148, filed on Mar. 30, 2015.

(51) Int. Cl. G10L 15/02

(52) U.S. Cl. CPC G10L 15/02

(57) ABSTRACT

The subject matter of this specification can be embodied in, among other things, a system configured to receive first utterances spoken by a user, determine a first voice action and parameters, generate a first voice action string, store the first voice action string in a collection of voice action strings, receive second utterances, determine a second voice action and parameters, generate a second voice action string, store the second voice action string in the collection, receive third utterances, determine a third voice action for accessing one or more voice action strings that are stored in the collection, select a particular voice action string from the collection based at least on the third voice action, and provide the particular voice action string for output.

### CROSS-REFERENCE TO RELATED MATTER

This application claims priority to U.S. Provisional Application Ser. No. 62/140,148, filed on Mar. 30, 2015, the entire contents of which are hereby incorporated by reference.

### TECHNICAL FIELD

This disclosure relates generally to speech recognition.

### BACKGROUND

Speech recognition includes processes for converting spoken words to text or other data. In general, speech recognition systems translate verbal utterances into a series of computer-readable sounds and compare those sounds to known words. For example, a microphone may accept an analog signal, which is converted into a digital form that is then divided into smaller segments. The digital segments can be compared to elements of a spoken language. Based on this comparison, and an analysis of the context in which those sounds were uttered, the system is able to recognize the speech.

A typical speech recognition system may include an acoustic model, a language model, and a dictionary. Briefly, an acoustic model includes digital representations of individual sounds that are combinable to produce a collection of words, phrases, etc. A language model assigns a probability that a sequence of words will occur together in a particular sentence or phrase. A dictionary transforms sound sequences into words that can be understood by the language model.

### SUMMARY

Described herein is a speech recognition process that may perform the following operations.

In a first aspect, a computer-implemented method includes receiving a set of one or more utterances spoken by a user, determining, from the set of one or more utterances (i) a voice action and (ii) one or more parameters associated with the voice action, generating, based on the (i) the voice action and (ii) the one or more parameters associated with the voice action, a voice action string, and storing the voice action string in a collection of voice action strings.

Various implementations can include some, all, or none of the following features. The voice action string can generated as a grammatically complete sentence. The set of one or more utterances can be received as a single phrase uttered by the user. Receiving a set of one or more utterances spoken by a user can include receiving a first utterance, determining from the first utterance the voice action, providing a prompt for output, the prompt requesting the user to utter one or more parameters associated with the voice action, and receiving, in response to the prompt, a second utterance corresponding to one or more parameters associated with the voice action. Receiving a set of one or more utterances spoken by a user can include receiving a first utterance, determining from the first utterance one or more parameters associated with one or more voice actions, providing a prompt for output, the prompt requesting the user to utter a voice action, and receiving, in response to the prompt, a second utterance corresponding to the voice action.

In a second aspect, a system includes a data processing apparatus and a non-transitory memory storage storing instructions executable by the data processing apparatus. Upon such execution the data processing apparatus is caused to perform operations including receiving a set of one or more utterances spoken by the user, determining from the set of one or more utterances a voice action for accessing one or more voice action strings that are stored in a collection of voice action strings, selecting a particular voice action string from the collection of voice action strings based at least on the voice action, and providing the particular voice action string for output.

Various embodiments can include some, all, or none of the following features. The voice action strings can be stored as grammatically complete sentences. The set of one or more utterances can be received as a single phrase uttered by the user. Receiving a set of one or more utterances spoken by a user can include receiving a first utterance, determining from the first utterance the voice action, providing a prompt for output, the prompt requesting the user to utter one or more parameters associated with the voice action, and receiving, in response to the prompt, a second utterance corresponding to one or more parameters associated with the voice action. Receiving a set of one or more utterances spoken by a user can include receiving a first utterance, determining from the first utterance one or more parameters associated with one or more voice actions, providing a prompt for output, the prompt requesting the user to utter a voice action, and receiving, in response to the prompt, a second utterance corresponding to the voice action.

In a third aspect, a non-transitory computer readable medium stores instructions executable by a data processing apparatus and that upon such execution cause the data processing apparatus to perform operations including receiving a first set of one or more utterances spoken by a user, determining, from the first set of one or more utterances, (i) a first voice action, and (ii) one or more parameters associated with the first voice action, generating, based on the (i) the first voice action and (ii) the one or more parameters associated with the first voice action, a first voice action string, storing the first voice action string in a collection of voice action strings, receiving a second set of one or more utterances spoken by the user, determining, from the second set of one or more utterances, (i) a second voice action, and (ii) one or more parameters associated with the second voice action, generating, based on the (i) the second voice action and (ii) the one or more parameters associated with the second voice action, a second voice action string, storing the second voice action string in the collection of voice action strings, receiving a third set of one or more utterances spoken by the user, determining, from the third set of one or more utterances, a third voice action for accessing one or more voice action strings that are stored in the collection of voice action strings, selecting a particular voice action string from the collection of voice action strings based at least on the third voice action, and providing the particular voice action string for output.

Various implementations can include some, all, or none of the following features. At least one of the first voice action string and the second voice action string can be generated as grammatically complete sentences. At least one of the first set of one or more utterances and the second set of one or more utterances can be received as a single phrase uttered by the user. Receiving a first set of one or more utterances spoken by a user can include receiving a first utterance, determining from the first utterance the first voice action, providing a prompt for output, the prompt requesting the user to utter one or more parameters associated with the first voice action, and receiving, in response to the prompt, a second utterance corresponding to one or more parameters associated with the first voice action. Receiving a first set of one or more utterances spoken by a user can include receiving a first utterance, determining from the first utterance one or more parameters associated with one or more voice actions, providing a prompt for output, the prompt requesting the user to utter a voice action, and receiving, in response to the prompt, a second utterance corresponding to the first voice action.

In a fourth aspect, a computer-implemented method includes receiving a first set of one or more utterances spoken by a user, determining, from the first set of one or more utterances, (i) a first voice action, and (ii) one or more parameters associated with the first voice action, and generating, based on the (i) the first voice action and (ii) the one or more parameters associated with the first voice action, a voice action string.

Various implementations can include some, all, or none of the following features. The voice action string can be generated as one or more grammatically complete sentences. The computer-implemented method can also include storing the voice action string in a collection of voice action strings. The computer-implemented method can also include receiving a second set of one or more utterances spoken by the user, determining, from the second set of one or more utterances, a second voice action for accessing one or more voice action strings that are stored in the collection of voice action strings, and selecting a particular voice action string from the collection of voice action strings based at least on the second voice action. The computer-implemented method can also include providing the particular voice action string for output.

The systems and techniques described here may provide one or more of the following advantages. First, a system can provide users of voice command interfaces with ways to recall previous actions. Second, the system can record previous voice actions in a format that is compact, computationally efficient, and can be queried to identify usage patterns. Third, the system can assist the user by helping the user recall previous actions and, at the user's discretion, repeat selected previous actions. Fourth, by recalling previous actions, the system can help the user better understand why the outcome of a voice command may not have been what the user expected.

The details of one or more implementations are set forth in the accompanying drawings and the description below. Other features and advantages will be apparent from the description and drawings, and from the claims.

### DESCRIPTION OF DRAWINGS

FIG. 1 shows, conceptually, an example of a speech recognition system.

FIG. 2 shows an example interaction between a user and a voice command application.

FIG. 3A shows an example interaction between a user and a voice command application.

FIG. 3B shows an example voice action history.

FIG. 4A shows an example interaction between a user and a voice command application.

FIG. 4B shows an example voice action history.

FIG. 5 is a flow diagram of an example process for using a voice action history.

FIG. 6 shows an example computer system.

### DETAILED DESCRIPTION

Described herein are processes for performing speech recognition. The processes include recognizing and logging one or more voice commands, and then recognizing and responding to a voice command requesting voice action history information.

In general, a user can interact with a computing device such as a laptop computer, a smartphone, a tablet computer, a wearable computer, or other such device through voice commands and audible spoken responses. Conversations between humans are contextual in nature, where the listener generally interprets what the speaker is saying within the context of recent topics in the conversation. But human conversation also allows for historical shifts in context, where the speaker may alert the listener that he/she is switching context to something discussed earlier (e.g., “let's go back to what you said about . . . ”) or that he/she wants the listener's help in returning to an earlier context (e.g., “I lost my train of thought; what was I just talking about?”, “who did you say was on vacation?”).

This document describes examples of how historical context of human-machine voice interactions can be used to make spoken machine control interfaces more closely resemble human-to-human conversations. By emulating some of the contextual and historical aspects of human speech, users' experiences and satisfaction with voice interfaces for human-machine interactions may be improved.

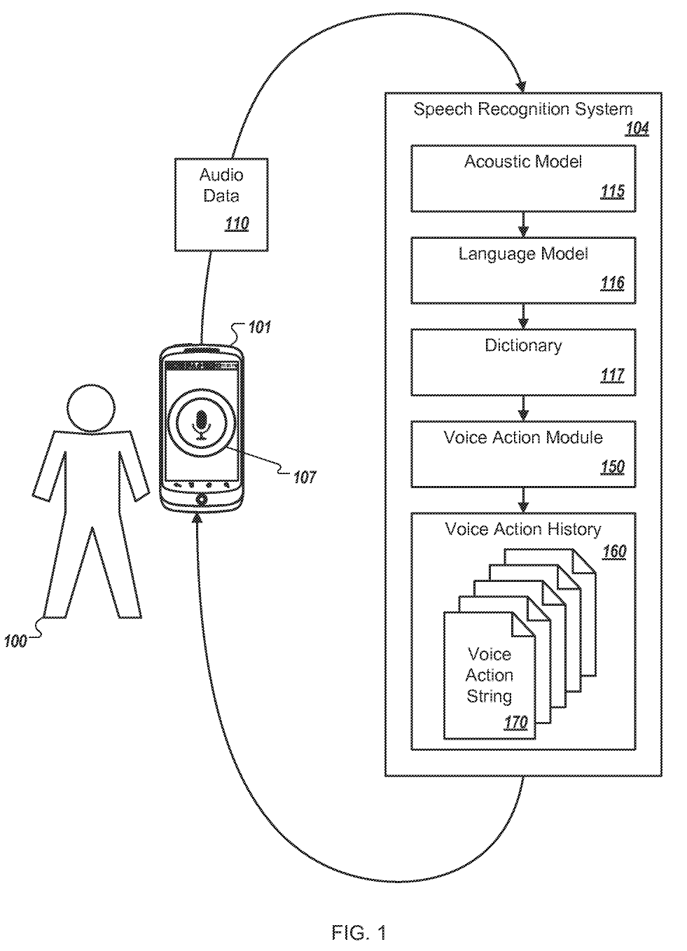

FIG. 1 shows a conceptual example of a system for performing speech recognition according to the processes described herein. In the example of FIG. 1, a user 100 of a mobile device 101 accesses a speech recognition system 104. In this example, the mobile device 101 is a cellular telephone having advanced computing capabilities, known as a smartphone. Speech recognition system 104 may be hosted by one or more server(s) that is/are remote from mobile device 101. For example, speech recognition system 104 may be part of another service available to users of the mobile device 101 (e.g., a help service, a search service, etc.).

In this example, mobile device 101 may include an application 107 (“app”) that receives input audio (e.g., speech) provided by user 100 and that transmits data 110 representing that input audio to the speech recognition system 104. App 107 may have any appropriate functionality, e.g., it may be a search app, a messaging app, an email app, and so forth. In this regard, an app is used as an example in this case. However, all or part of the functionality of the app 107 may be part of another program downloaded to mobile device 101, part of another program provisioned on mobile device 101, part of the operating system of the mobile device 101, or part of a service available to mobile device 101.

In an example, app 107 may ask user 100 to identify, beforehand, the languages that user 100 speaks. The user 100 may select, e.g., via a touch-screen menu item or voice input, the languages that user 100 expects to speak or have recognized. In some implementations, user 100 may also select among various accents or dialects. Alternatively, the user's languages, accents, and/or dialects may be determined based on the audio input itself or based on prior audio or other appropriate input.

To begin the speech recognition process, user 100 speaks a voice command into mobile device 101. App 107 generates audio data 110 that corresponds to the input speech, and forwards that audio data to speech recognition system 104. Speech recognition system 104 includes one or more of each of the following: an acoustic model 115, a language model 116, a dictionary 117, a voice action module 150, and a voice history 160. In this example implementation, acoustic model 115 includes digital representations of individual sounds that are combinable to produce a collection of words, phrases, etc. Language model 116 assigns a probability that a sequence of words will occur together in a particular sentence or phrase. Dictionary 117 transforms sound sequences into words that can be understood by language model 116. Voice action module 150 identifies strings of recognized words that correspond to voice actions (e.g., voice command-initiated device actions) that can be performed or initiated by the mobile device 101. Voice action history 160 stores a collection of voice action strings 170 that have been identified by the voice action module 150.

In an example implementation, the user 100 may issue a voice command, which is recognized by the speech recognition system 104 and performed by the voice action module 150 as a voice action, and a record of which is stored in the voice action history 160 as one of the voice action strings 170. The user 100 may issue another voice command that is identified by the voice action module 150 as a request for voice action history information (e.g., “action history”, “repeat”, “what was that?”, “what did I do last”, “who did I call?”), and the voice action module 150 may respond by providing one or more of the voice action strings 170 stored as the voice action history 160.

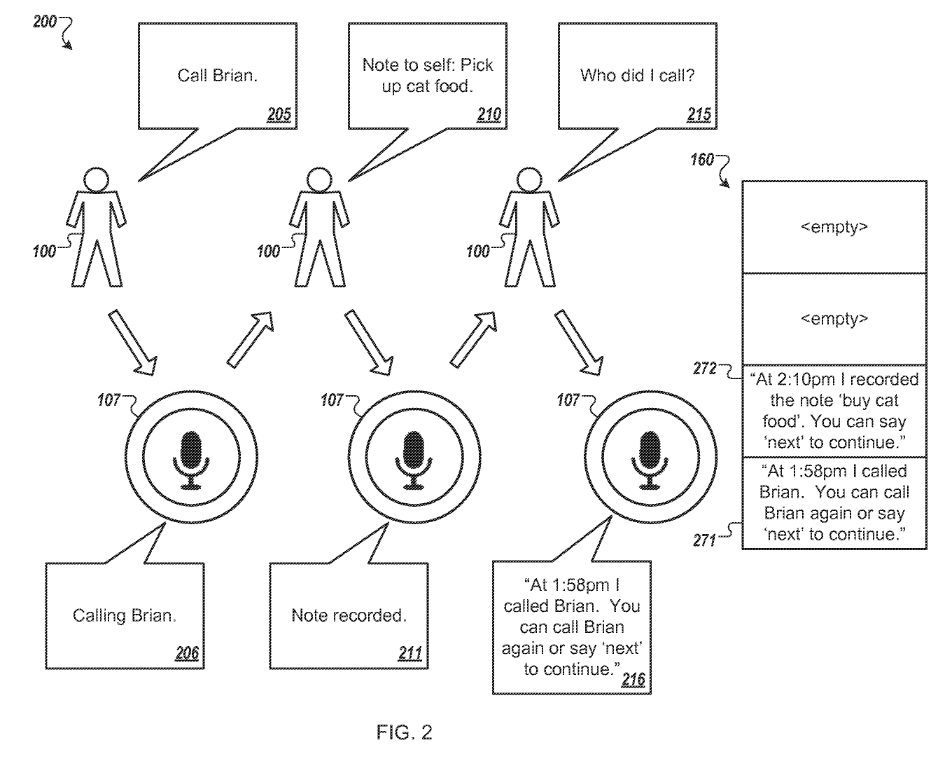

FIG. 2 shows an example interaction 200 between the user 100 and the voice action application 107 of FIG. 1. In the illustrated example, the user 100 says “Call Brian” as a voice command 205. The application 107 recognizes the voice command 205, and provides the phrase “calling Brian” as a response 206 that describes a voice action performed in response to the voice command 205 (e.g., placing a call to “Brian”). The application 107 also stores a voice action string 271 in the voice command history 160 (e.g., “At 1:58 pm I called Brian. You can call Brian again or say ‘next’ to continue.”)

In the present example, the voice action string 271 is formatted as a substantially grammatically complete sentence that describes the voice action that was performed (e.g., “I called Brian”), an indication of the time and/or date that the voice action was performed (e.g., “at 1:58 pm”), and a description of actions that the user 100 can take in the context of the voice action string 271 (e.g., “You can call Brian again or say ‘next’ to continue”).

In the illustrated example, the user 100 next says “Note to self: Pick up cat food” as a voice command 210. The application 107 then recognizes the voice command 210, and provides the phrase “note recorded” as a response 211 that describes a voice action performed in response to the voice command 210 (e.g., recording a reminder to pick up cat food). The application 107 also stores a voice action string 272 in the voice action history 160 (e.g., “At 2:10 pm I recorded the note ‘buy cat food’. You can say ‘next’ to continue”).

In the present example, the voice action string 272 is formatted as a substantially grammatically complete sentence that describes the voice action that was performed (e.g., “I recorded the note ‘buy cat food’”), an indication of the time and/or date that the voice action was performed (e.g., “at 2:10 pm”), and a description of actions that the user 100 can take in the context of the voice action string 272 (e.g., “You can say ‘next’ to continue”).

In the illustrated example, the user 100 next says “Who did I call?” as a voice command 215. The application 107 then recognizes the voice command 215 as a voice action to be performed upon the voice action history 160 itself. In this example, the application 107 can identify the verb “call” from the voice command 215, and parse the voice action history 160 to identify one or more voice action strings that chronicle voice actions that were “calls” (e.g., audio or video calls initiated from the mobile device 101). In the present example, the application 107 identifies the voice action string 271 as describing a “call”, and provides the voice action string 271 as a response 216. In some implementations, the response 216 can be spoken by (e.g., text to speech) or displayed as text on the mobile device 101.

In some implementations, the user 100 may choose to interact further with the voice action history 160 by issuing a voice command in the context of the voice action string 271. For example, the user 100 may say “call again” or “redial” as a voice command and the application 107 may identify the voice command as one that can be performed in the context of a recently provided voice action string (e.g., the application may infer that “Brian” was “called” and should be called again in response to the voice command “call again”). In another example, the user 100 may say “next”, “keep going”, “who else” as a voice command, and the application 107 may identify the voice command as an instruction to provide another voice action string to the user.

In some implementations, the voice action history 160 may be filtered based on a voice command. For example the user 100 may say “who did I call”, and then say “next”, and the application 107 may infer that the user 100 wishes to retrieve the next call-related voice action string, but not other types of voice action strings in the voice action history 160.

In some implementations, voice actions performed upon the voice action history 160 may not be stored as voice action strings 170. For example, the voice action performed in response to the voice command 215 may not cause a voice action string 170 to be stored in the voice action history 160.

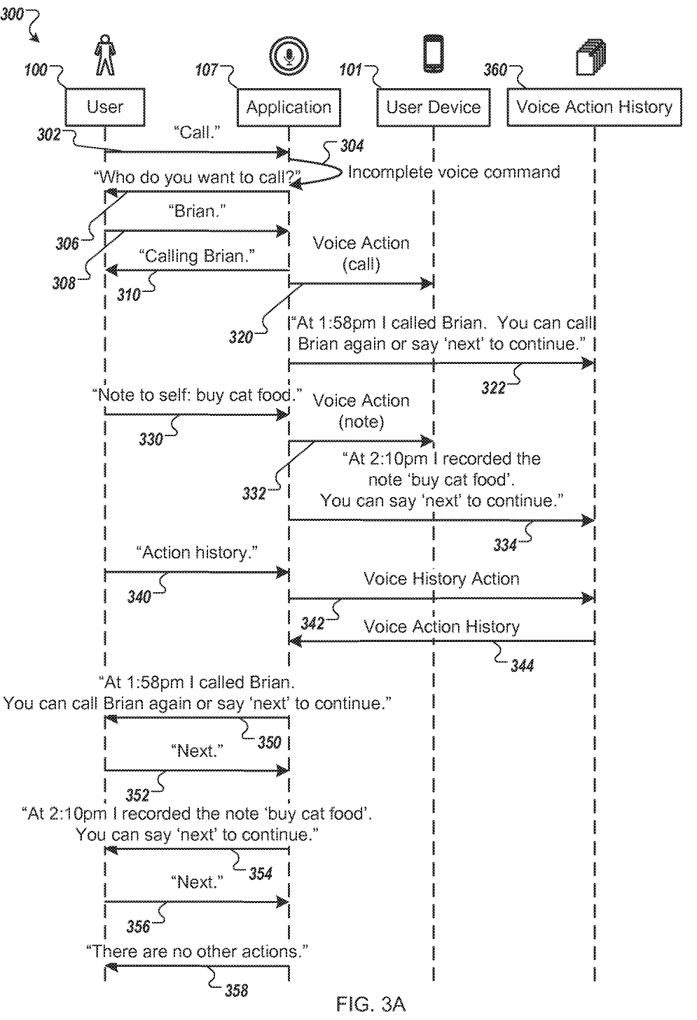

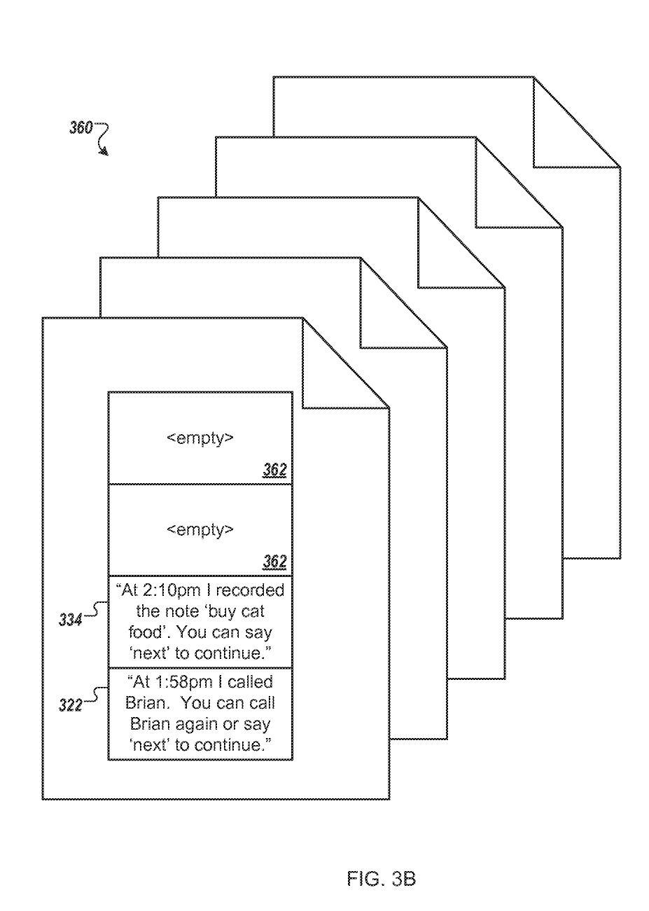

FIG. 3A shows an example interaction 300 between the user 100 and a voice command application 107 running on the mobile device 101. The user 100 starts the interaction 300 by speaking the voice command 302 (“call”) to the application 107. The application 107 processes 304 the voice command 302 and determines that the voice command 302 is grammatically incomplete (e.g., the user has not said who to call). In response to the determination, the application 107 responds by prompting the user 100 to provide more information in order to complete the voice command 302 (e.g., “who do you want to call?”). In the illustrated example, the user 100 provides a response 308 (e.g., “Brian”).

Once the application 107 has determined that enough information has been received from the user 100 to perform a complete voice action, the application 107 sends a notification 310 to the user 100 to inform the user 100 that the voice action is about to be performed (e.g., “Calling Brian”). The application 107 sends a voice action request 320 to the mobile device 101 (e.g., to initiate a call to Brian). The application 107 also stores a voice action string 322 in a voice action history 360. The voice action string 322 includes a grammatically complete description of the voice action request 320, information that describes the time and/or date when the voice action request 320 was sent, and information that describes actions that the user 100 can take with regard to the voice action request 320.

In the illustrated example, the voice action string 322 includes “At 1:58 pm I called Brian. You can call Brian again or say ‘next’ to continue.” In some implementations, the voice action string 322 may be stored in the voice action history as audio data, class data, cached data, or any other appropriate data form that can store a representation of the voice action strings.

In the example interaction 300, the user 100 then speaks a voice command 330 (e.g., “Note to self: buy cat food”). The application 107 responds by sending a voice action request 332 to the mobile device 101 (e.g., to record a note to buy cat food) and by storing a voice action string 334 in the voice action history 360. The voice action string 334 includes a grammatically complete description of the voice action request 332, information that describes the time and/or date when the voice action request 332 was sent, and information that describes actions that the user 100 can take with regard to the voice action request 332. In the illustrated example, the voice action string 334 includes “At 2:10 pm I recorded the note ‘buy cat food’. You can say ‘next’ to continue.”

FIG. 3B shows an example voice action history 360. In some implementations, the voice action history 360 can be the voice action history 160 and the voice action strings 322 and 334 can be the voice action strings 170 and of FIG. 1. In general, the voice action history 360 is a collection of voice action strings 170 stored in the order in which they were received from the voice action module 150. For example, in the interaction 300 the voice action string 322 was stored first, and the voice action string 334 was stored second. A collection of one or more empty voice action sting slots 362 are available to store additional voice action strings 170 if needed.

In the ordered context of the voice action history 360, the voice action strings 322 and 334 can be interpreted in the context of their relative positions to each other. For example, the voice action string 322 says ““At 1:58 pm I called Brian. You can call Brian again or say ‘next’ to continue.” In the context of the position of the voice action string 322 within the voice action history 360, the phrase “say ‘next’ to continue” can be interpreted as referring to the voice action string 334.

Referring again to FIG. 3A, the user 100 speaks a voice command 340 (e.g., “Action history”). The application 107 responds by performing a voice history action 342 on the voice action history 360. The voice history action 342 causes the mobile device 101 to access the voice action history 360 and return one or more of the voice action strings 322, 334 to the application 107.

The application 107 provides the voice action string 322 as a response 350 to the user 100 (e.g., “At 1:58 pm I called Brian. You can call Brian again or say ‘next’ to continue.”). In the illustrated example, the user 100 then speaks a voice command 352 (e.g., “next”) to navigate to another voice action string. The voice application 107 provides the voice action string 334 as a response 354 to the user (e.g., “At 2:10 pm I recorded the note ‘buy cat food’. You can say ‘next’ to continue.”). In the illustrated example, the user 100 then speaks a voice command 356 (e.g., “next”) to navigate to another voice action string, but since the voice action history 360 has no additional voice action strings 170 other than the voice action strings 322 and 334, the application 107 provides the user 100 with a response 358 that informs the user 100 that no other voice action strings 170 are available (e.g., “There are no other actions.”).

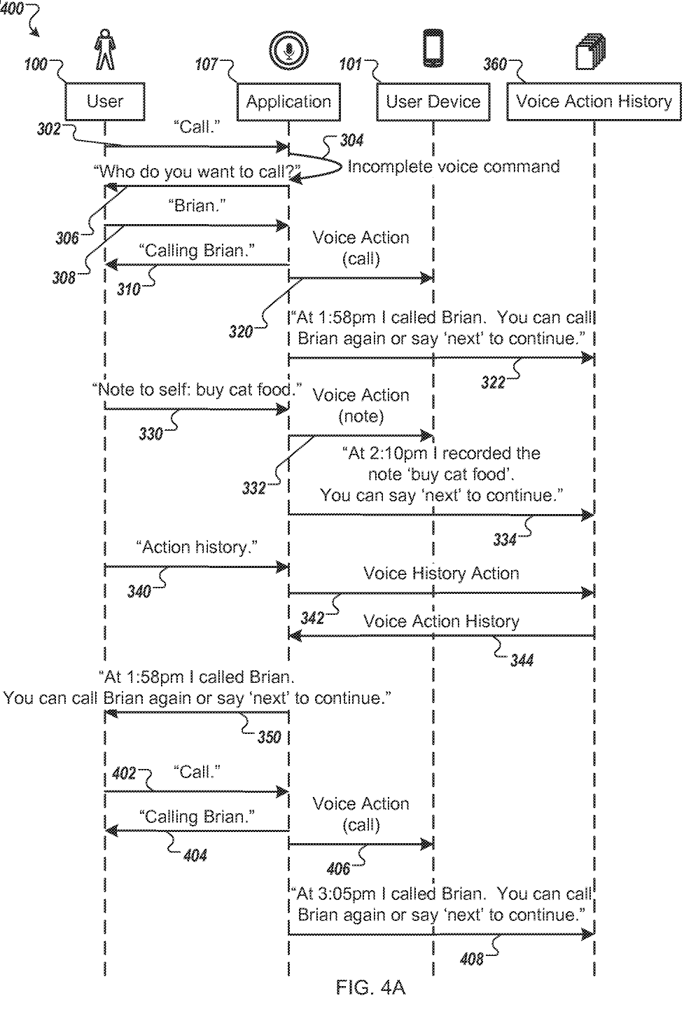

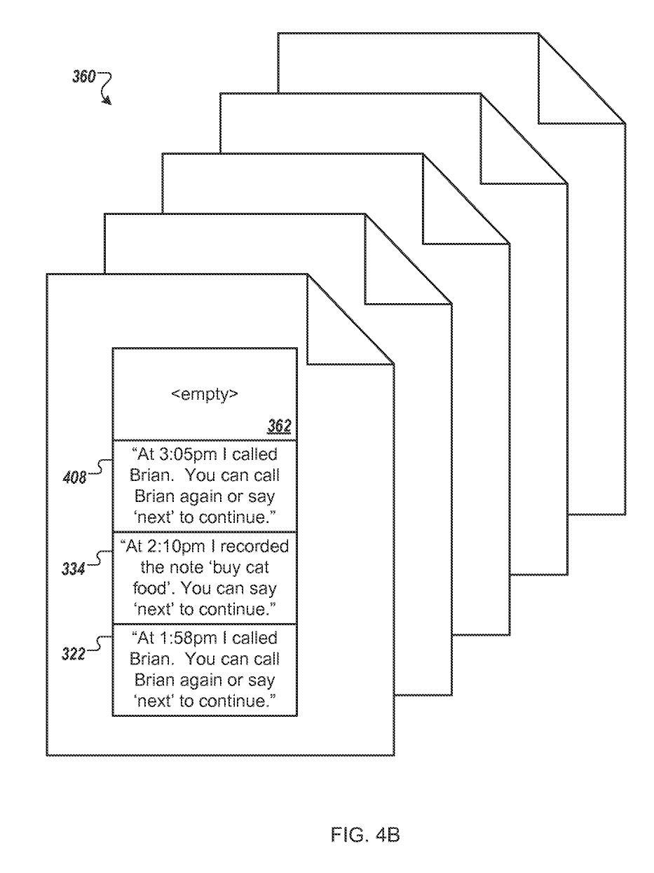

FIG. 4A shows an example interaction 400 between the user 100 and the voice command application 107 of FIG. 1. The example interaction 400 represents another example outcome to the interaction 300 of FIG. 3A where the user 100 chooses a different voice history action option.

The interaction 400 includes the same collection of interactions 302-350 discussed in the description of FIG. 3A. However, in the present example, when the application 107 provides the response 350 to the user 107 (e.g., “At 1:58 pm I called Brian. You can call Brian again or say ‘next’ to continue.”), the user 100 then speaks a voice command 402 (e.g., “Call.”).

The application 107 interprets the voice command 402 in the context of the voice action history 360. For example, unlike the voice command 302 of the interaction 300, in which the application 107 did not have enough explicit or contextual information to perform the voice command 302, in the example interaction 400 the application 107 can respond to the voice command 402 in the context of the voice action string 322 and the response 350 (e.g., “You can call Brian again”).

As such, the application 107 can interpret the voice command 402 as a voice command to initiate a “call” to “Brian”. The application 107 sends a notification 404 to the user 100 to inform the user 100 that a voice action is about to be performed (e.g., “Calling Brian”). The application 107 sends a voice action request 406 to the mobile device 101 (e.g., to initiate a call to Brian). The application 107 also stores a voice action string 408 in the voice action history 360. The voice action string 408 includes a grammatically complete description of the voice action request 406, information that describes the time and/or date when the voice action request 406 was sent, and information that describes actions that the user 100 can take with regard to the voice action request 406. In the illustrated example, the voice action string 406 includes “At 3:05 pm I called Brian. You can call Brian again or say ‘next’ to continue.”

FIG. 4B shows another example configuration of the voice action history 360 that includes the voice action strings 322, 334, and 408 stored in the order in which they were received from the voice action module 150. For example, in the interaction 400 the voice action string 322 was stored first, the voice action string 334 was stored second, and the voice action string 408 was stored third. A collection of one or more empty voice action sting slots 362 are available to store additional voice action strings 170 if needed.

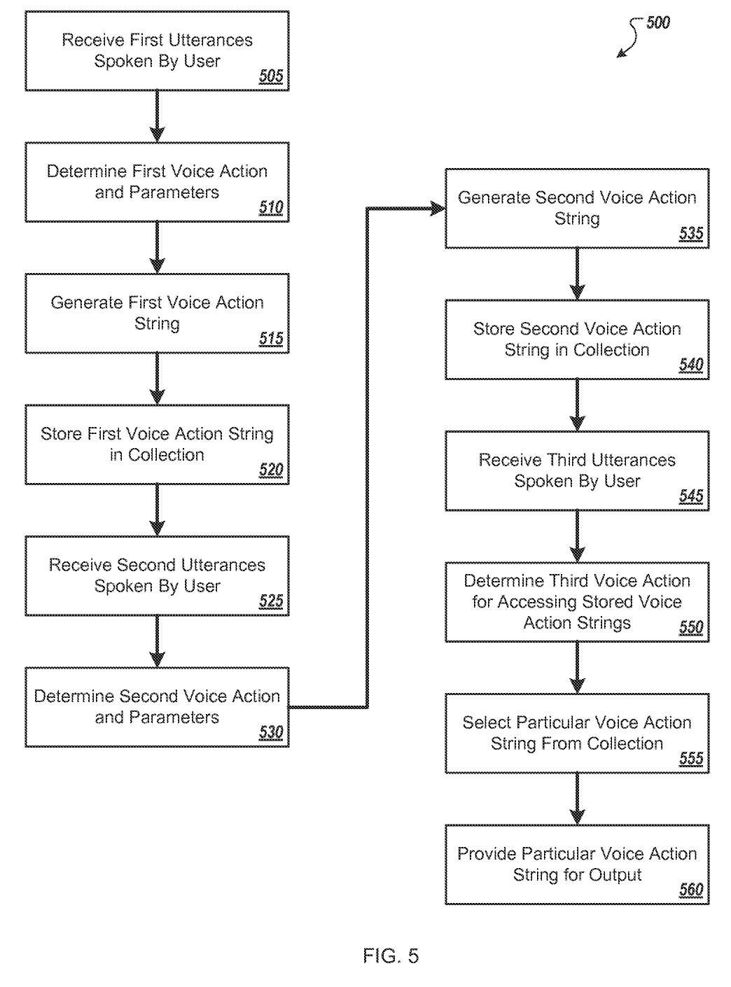

FIG. 5 is a flow diagram of an example process 500 for using a voice action history. In some implementations, the process 500 may be performed by the mobile device 101 or any other appropriate computing device. In some implementations, the process 500 may be used to perform one or more of the example interactions 200, 300, or 400 of FIGS. 2, 3A, and 4A.

At 505, a first set of one or more utterances spoken by a user is received. For example, the user 101 can speak the voice commands 302 and 308 to the application 107 running on the mobile device 101.

In some implementations, receiving the first set of one or more utterances spoken by a user can include receiving a first utterance, determining from the first utterance the first voice action, providing a prompt for output, the prompt requesting the user to utter one or more parameters associated with the first voice action, and receiving, in response to the prompt, a second utterance corresponding to one or more parameters associated with the first voice action. For example, the user can speak the voice command 302 as “call”. The application 107 can determine 304 that the voice command 302 includes a voice action keyword but not enough additional command information in order to perform the voice action. The application 107 prompts the user 107 with the response 306 “who do you want to call?” The user 100 can then provide the missing information by speaking the voice command 308, e.g., “Brian”.

In some implementations, receiving the first set of one or more utterances spoken by a user can include receiving a first utterance, determining from the first utterance one or more parameters associated with one or more voice actions, providing a prompt for output, the prompt requesting the user to utter a voice action, and receiving, in response to the prompt, a second utterance corresponding to the first voice action. For example, the user 100 may utter the word “Brian”, and the application 107 may recognize the word is a name of a person and that voice actions may be performed for the named person. In response, the application 107 may prompt the user for a voice command that identifies a voice action to be performed. For example, the application 107 may ask the user 100 “Do you wish to call, email, or message Brian?” The user 100 may respond by saying “email”. The application 107 may then process a voice action as “email Brian”, and/or prompt the user for additional information such as “what is the subject of the email” or “please speak the content of the email”. The application may also store a grammatically complete sentence describing the voice action to the voice action history 360 (e.g., “at 4:18 pm you sent an email to Brian with the subject . . . . The message was . . . ”).

At 510, a first voice action and one or more parameters associated with the first voice action are determined from the first set of one or more utterances. For example, the application 107 can identify that the voice commands 302 and 308 include the voice action word “call” and the parameter “Brian”.

At 515, a first voice action string is generated based on the first voice action and the one or more parameters associated with the first voice action. For example, the application 107 can create the voice action string 322 (e.g., “At 1:58 pm I called Brian. You can call Brian again or say ‘next’ to continue.”).

At 520, the first voice action string is stored in a collection of voice action strings. For example, the voice action string 322 can be stored as part of the voice action history 360.

At 525, a second set of one or more utterances spoken by the user is received. For example, the user 100 can speak the voice command 320 to the application 107.

At 530, a second voice action and one or more parameters associated with the second voice action are determined from the second set of one or more utterances. For example, the application 107 can identify that the voice command 320 includes the voice action phrase “note to self” and the parameter phrase “buy cat food”.

At 535, a second voice action string is generated based on the second voice action and the one or more parameters associated with the second voice action. For example, the application 107 generates the voice action string 334 (e.g., “At 2:10 pm I recorded the note ‘buy cat food’. You can say ‘next’ to continue.”).

In some implementations, at least one of the first voice action string and the second voice action string are generated as grammatically complete sentences. For example, the voice action string 322 is generated as the grammatically complete sentences “At 1:58 pm I called Brian. You can call Brian again or say ‘next’ to continue.”

In some implementations, at least one of the first set of one or more utterances and the second set of one or more utterances is received as a single phrase uttered by the user. For example, the user 100 can speak the voice command 330 as the single phrase “Note to self: buy cat food.”

At 540, the second voice action string is stored in the collection of the voice action strings. For example, the application 107 stores the voice action string 334 as part of the voice action history 360.

At 545, a third set of one or more utterances spoken by the user is received. For example, the user 107 can speak the voice command 340 to the application 107 (e.g., “Action history”).

At 550, a third voice action for accessing one or more voice action strings that are stored in the collection of voice action strings is determined from the third set of one or more utterances. For example, the application 107 can determine that the voice command 340 (e.g., “action history”) is a request for voice action history and perform a voice action that accesses voice action strings 170 stored in the voice action history 360.

In some implementations, a voice action that is identified as performing actions upon the voice action history may not have a corresponding voice action string 170 generated and/or stored in the voice action history 360. For example, in response to a voice command such as “action history” or “next”, the application 107 may store a string such as “at 6:33 pm you requested access to the voice action history” or “at 6:35 pm you navigated to the next voice action string in the voice action history.”

At 555, a particular voice action string is selected from the collection of voice action strings based at least on the third voice action. For example, the application can respond to the voice command 320 by selecting the voice action string 322 from the voice action history 360.

At 560, the particular voice command string is provided for output. For example, the application 107 can provide the voice action string 322 to the user 100 (e.g., “At 1:58 pm I called Brian. You can call Brian again or say ‘next’ to continue.”). In some implementations, voice action strings may be provided to the user as machine-generated speech output.

In some implementations, another voice command may be received in response to the output provided at 560. For example, in the interaction 400 the user 100 may say the voice command 402 “call” and the application 107 can initiate the voice action 406 to place a call to “Brian” based in part on the context of the response 350 output to the user 100. In another example, in the interaction 300 the user 100 may say the voice command 352 “next” and the application 107 can respond by providing the voice action string 334 to the user 107.

In some implementations, the process of interacting with the voice action history can be ended with a voice command. For example, the application 107 may prompt the user with “At 1:58 pm I called Brian. You can call Brian again or say ‘next’ to continue,” and the user may end the interaction by uttering a voice command that can be understood by the application 107, such as “stop”, “exit”, “end Action History”, “home”, “return”, “no”, or any other appropriate keyword or phrase.

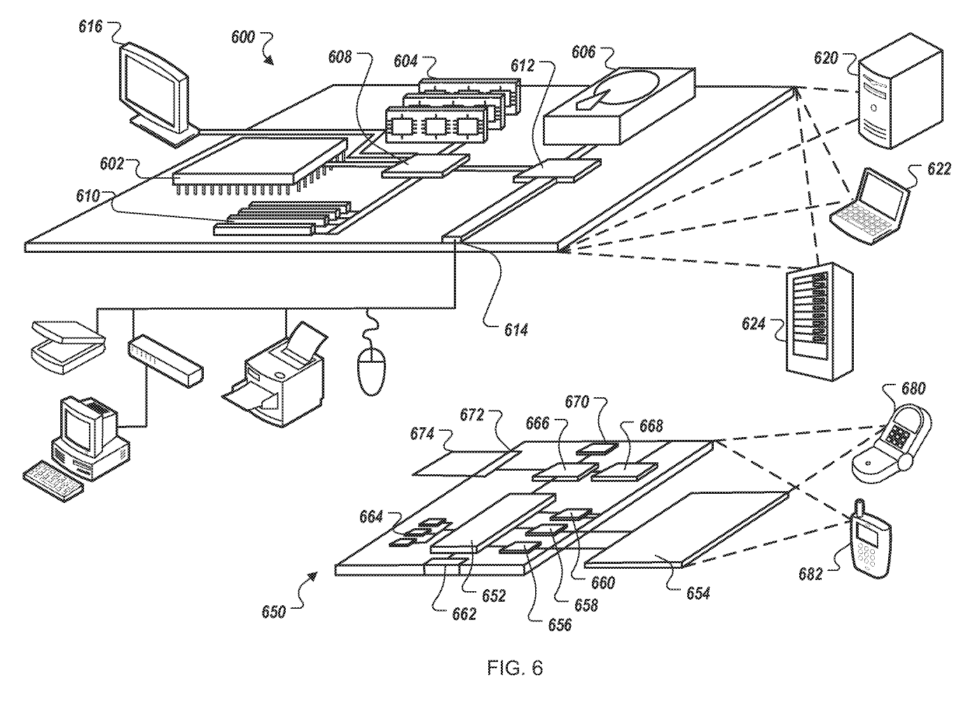

FIG. 6 is a block diagram of computing devices 600, 650 that may be used to implement the systems and methods described in this document, either as a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. In some implementations, the computing device 650 can be the mobile device 101 of FIG. 1. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of duties is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 may communicate wirelessly through communication interface 666, which may include digital signal processing circuitry where necessary. Communication interface 666 may provide for communications under various modes or protocols, such as GSM voice calls, Voice Over LTE (VOLTE) calls, SMS, EMS, or MMS messaging, CDMA, TDMA, PDC, WCDMA, CDMA2000, GPRS, WiMAX, LTE, among others. Such communication may occur, for example, through radio-frequency transceiver 668. In addition, short-range communication may occur, such as using a Bluetooth, WiFi, or other such transceiver (not shown). In addition, GPS receiver module 670 may provide additional wireless data to device 650, which may be used as appropriate by applications running on device 650.

Device 650 may also communication audibly using audio codec 660, which may receive spoken information from a user and convert it to usable digital information. Audio codex 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A computer-implemented method comprising:
receiving a set of one or more utterances spoken by a user;
determining, from the set of one or more utterances, (i) a voice action, and (ii) one or more parameters associated with the voice action;
generating, based on the (i) the voice action and (ii) the one or more parameters associated with the voice action, a voice action string; and
storing the voice action string in a collection of voice action strings.

2. The method of claim 1, wherein the voice action string is generated as a grammatically complete sentence.

3. The method of claim 1, wherein the set of one or more utterances is received as a single phrase uttered by the user.

4. The method of claim 1, wherein receiving a set of one or more utterances spoken by a user comprises:
receiving a first utterance;
determining from the first utterance the voice action;
providing a prompt for output, the prompt requesting the user to utter one or more parameters associated with the voice action; and
receiving, in response to the prompt, a second utterance corresponding to one or more parameters associated with the voice action.

5. The method of claim 1, wherein receiving a set of one or more utterances spoken by a user comprises:
receiving a first utterance;
determining from the first utterance one or more parameters associated with one or more voice actions;
providing a prompt for output, the prompt requesting the user to utter a voice action; and
receiving, in response to the prompt, a second utterance corresponding to the voice action.

6. A system comprising:
a data processing apparatus; and
a non-transitory memory storage storing instructions executable by the data processing apparatus and that upon such execution cause the data processing apparatus to perform operations comprising:
receiving a set of one or more utterances spoken by the user;
determining, from the set of one or more utterances, a voice action for accessing one or more voice action strings that are stored in a collection of voice action strings;
selecting a particular voice action string from the collection of voice action strings based at least on the voice action; and
providing the particular voice action string for output.

7. The system of claim 6, wherein the voice action strings are stored as grammatically complete sentences.

8. The system of claim 6, wherein the set of one or more utterances is received as a single phrase uttered by the user.

9. The system of claim 6, wherein receiving a set of one or more utterances spoken by a user comprises:
receiving a first utterance;
determining from the first utterance the voice action;
providing a prompt for output, the prompt requesting the user to utter one or more parameters associated with the voice action; and
receiving, in response to the prompt, a second utterance corresponding to one or more parameters associated with the voice action.

10. The system of claim 6, wherein receiving a set of one or more utterances spoken by a user comprises:
receiving a first utterance;
determining from the first utterance one or more parameters associated with one or more voice actions;
providing a prompt for output, the prompt requesting the user to utter a voice action; and
receiving, in response to the prompt, a second utterance corresponding to the voice action.

11. A non-transitory computer readable medium storing instructions executable by a data processing apparatus and that upon such execution cause the data processing apparatus to perform operations comprising:
receiving a first set of one or more utterances spoken by a user;
determining, from the first set of one or more utterances, (i) a first voice action, and (ii) one or more parameters associated with the first voice action;
generating, based on the (i) the first voice action and (ii) the one or more parameters associated with the first voice action, a first voice action string;
storing the first voice action string in a collection of voice action strings;
receiving a second set of one or more utterances spoken by the user;
determining, from the second set of one or more utterances, (i) a second voice action, and (ii) one or more parameters associated with the second voice action;
generating, based on the (i) the second voice action and (ii) the one or more parameters associated with the second voice action, a second voice action string;
storing the second voice action string in the collection of voice action strings;
receiving a third set of one or more utterances spoken by the user;
determining, from the third set of one or more utterances, a third voice action for accessing one or more voice action strings that are stored in the collection of voice action strings;
selecting a particular voice action string from the collection of voice action strings based at least on the third voice action; and
providing the particular voice action string for output.

12. The non-transitory computer readable medium of claim 11, wherein at least one of the first voice action string and the second voice action string are generated as grammatically complete sentences.

13. The non-transitory computer readable medium of claim 11, wherein at least one of the first set of one or more utterances and the second set of one or more utterances is received as a single phrase uttered by the user.

14. The non-transitory computer readable medium of claim 11, wherein receiving a first set of one or more utterances spoken by a user comprises:
receiving a first utterance;
determining from the first utterance the first voice action;
providing a prompt for output, the prompt requesting the user to utter one or more parameters associated with the first voice action; and
receiving, in response to the prompt, a second utterance corresponding to one or more parameters associated with the first voice action.

15. The non-transitory computer readable medium of claim 11, wherein receiving a first set of one or more utterances spoken by a user comprises:
receiving a first utterance;
determining from the first utterance one or more parameters associated with one or more voice actions;
providing a prompt for output, the prompt requesting the user to utter a voice action; and
receiving, in response to the prompt, a second utterance corresponding to the first voice action.

16. A computer-implemented method comprising:
receiving a first set of one or more utterances spoken by a user;
determining, from the first set of one or more utterances, (i) a first voice action, and (ii) one or more parameters associated with the first voice action; and
generating, based on the (i) the first voice action and (ii) the one or more parameters associated with the first voice action, a voice action string.

17. The method of claim 16, wherein the voice action string is generated as one or more grammatically complete sentences.

18. The computer-implemented method of claim 16, further comprising storing the voice action string in a collection of voice action strings.

19. The computer-implemented method of claim 17, further comprising:
receiving a second set of one or more utterances spoken by the user;
determining, from the second set of one or more utterances, a second voice action for accessing one or more voice action strings that are stored in the collection of voice action strings; and
selecting a particular voice action string from the collection of voice action strings based at least on the second voice action.

20. The computer-implemented method of claim 18, further comprising providing the particular voice action string for output.
